(19) United States
(12) Patent Application Publication
(10) Pub. No.: US 2020/0086540 A1
(43) Pub. Date: Mar. 19, 2020

(54) INJECTION MOLDING SYSTEM AND APPARATUS

(71) Applicant: Evan Goodwin, Acton (CA)

(72) Inventor: Evan Goodwin, Acton (CA)

(21) Appl. No.: 16/569,895

(22) Filed: Sep. 13, 2019

Related U.S. Application Data
(60) Provisional application No. 62/731,166, filed on Sep. 14, 2018.

(51) Int. Cl. B29C 45/16; B29C 45/18

(52) U.S. Cl. CPC B29C 45/1635; B29C 45/1816; B29C 45/1618

(57) ABSTRACT

This disclosure provides an injection molding system for use with a material, the system comprising: a heated barrel; a member mounted in the barrel for melting the material and for ejecting molten material; a pair of mold plates, one of the pair being operatively coupled to the barrel in use, the other of the pair being movable relative to other plate for movement between a closed position and an open position, characterized in that the barrel is defined by a nested part and a protruding part, the nested part having an external end which is disposed exteriorly of the one of the pair of mold plates and an internal end which, in use, is disposed interiorly of the one of the pair of mold plates and engaged therewith, the protruding part, in use, extending to the nested part and being releasably coupled thereto in end-to-end communicating relation.

### CROSS REFERENCE TO RELATED APPLICATIONS

The application claims priority and benefit to U.S. provisional application Ser. No. 62/731,166 filed on Sep. 14, 2018 which is incorporated herein by reference.

### TECHNICAL FIELD

The invention relates generally to injection molding systems and more particularly, to injection molding systems having an auxiliary injection unit for co-molding multi-material or multi-colour parts.

### BACKGROUND

Multi-material injection molding applications typically require an injection molding device that has two or more injection units for delivering the two or more materials to a mold cavity. Multi-injection unit molding systems/machines are a significant capital investment for users due to the increased complexity involved in having multiple injection units associated and operating together.

Auxiliary or secondary injection units have been developed that may be used with injection molding machines having a single injection unit in order to provide a means for processing the additional material required for multi-material injection molding applications. Such auxiliary injection units may be attached to the injection molding machine or the injection molding system such that the extruder nozzle of the auxiliary injection unit interfaces with the second material inlet component of the injection molding system.

In such cases, the number of parts and complication of the multi-injection system is relatively large and the overall footprint, or space required to run such systems, is relatively large.

### SUMMARY

This disclosure provides an injection molding system for use with a material, the system comprising: a heated barrel for receiving the material; a member mounted in the barrel, the member being adapted, in combination with the barrel, to melt the material to produce a molten material and to eject a shot of the molten material from the barrel; a pair of mold plates, one of the pair being operatively coupled to the barrel in use, the other of the pair being movable relative to the one of the pair for movement between: a closed position, wherein the pair of mold plates define a cavity for receiving the shot and molding a part; and an open position, wherein the other of the pair is disposed in spaced relation to the one of the pair for release of the part, characterized in that the barrel is defined by a nested part and a protruding part, the nested part having an external end which is disposed exteriorly of the one of the pair of mold plates and an internal end which, in use, is disposed interiorly of the one of the pair of mold plates and engaged therewith, the protruding part, in use, extending to the nested part and being releasably coupled thereto in end-to-end communicating relation.

This disclosure also provides a co-injection molding system for use with a primary material and a secondary material, the system comprising: the injection molding system outlined above, wherein the material is the secondary material; a principal barrel for receiving the primary material, the principal barrel being operatively coupled to the one of the pair of mold plates; a principal member mounted in the principal barrel, the principal member being adapted, in combination with the principal barrel, to melt the primary material to produce a molten primary material and to eject a shot of the molten primary material into the one of the pair of mold plates.

This disclosure further provides an apparatus comprising a pair of mold plates and an auxiliary injection molding mechanism.

The mold plates are movable relative to one another between: a closed position, wherein the pair of mold plates define a cavity; and an open position, wherein one of the pair is disposed in spaced relation to the other of the pair.

The auxiliary injection molding mechanism has a barrel for receiving, melting and ejecting a shot of a material into the cavity between the pair of mold plates and is characterized in that:
the barrel of the auxiliary injection molding mechanism comprises a nested part and a protruding part,
   the nested part having
      an external end which is disposed exteriorly of one of the pair of mold plates, and
      an internal end which, in use, is disposed interiorly of the one of the pair of mold plates and engaged therein;
   the protruding part, in use, extending to the nested part and being releasably coupled thereto in end-to-end communicating relation.

Advantages and features of the invention will become evident upon a review of the following detailed description and the appended drawings, the latter being briefly described hereinafter.

### BRIEF DESCRIPTION OF THE DRAWINGS

Reference will now be made, by way of example, to the accompanying drawings which show an example of the present application, in which:

FIG. 1 is a schematic view of a co-injection molding system according to an example of the present invention;

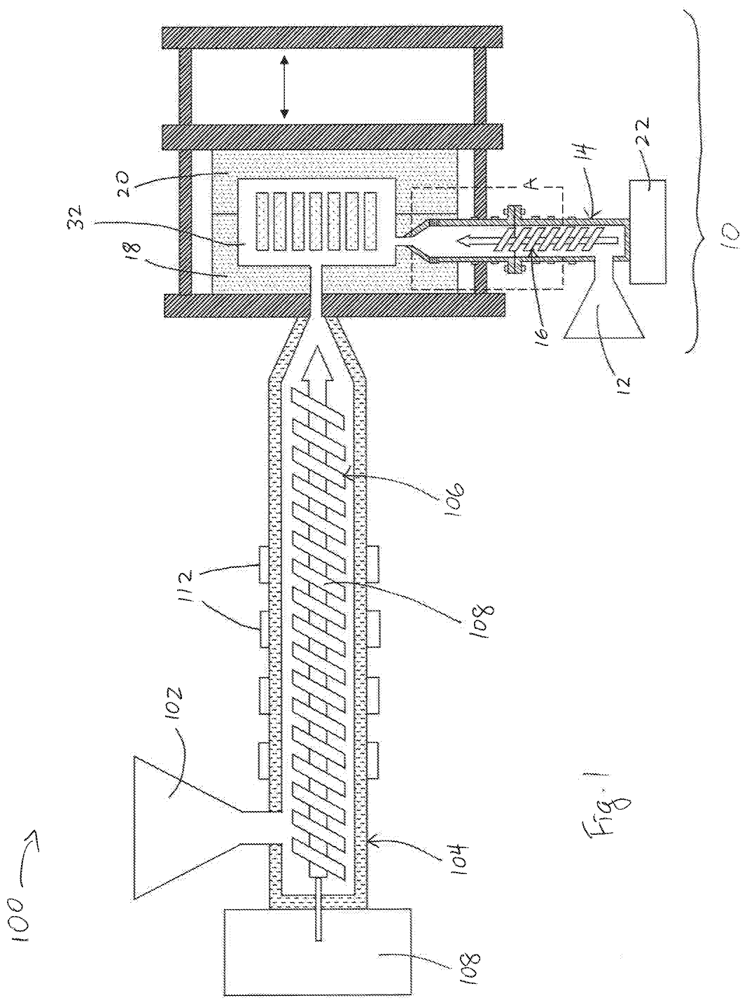

FIG. 2 is an enlarged view of portion A of FIG. 1; and

FIG. 3 is a perspective view of a portion of a barrel of FIG. 2 in isolation.

### DETAILED DESCRIPTION OF THE EXEMPLARY EMBODIMENTS SHOWN IN THE DRAWINGS

An example embodiment of an injection molding system 10 and a co-injection molding system 100 for use with one or more materials will be discussed. Injection molding system 10 will first be described.

### Systems

As seen in in the Figures, injection molding system 10 comprises a hopper 12, a heated barrel 14 in fluid communication with hopper 12, a member 16 mounted in barrel 14, a pair of mold plates 18, 20, and an actuator 22 in operating engagement with member 16.

Hopper 12 is funnel-shaped to receive pelletized raw material, and is positioned to be in fluid communication with barrel 14.

As shown, barrel 14 is generally tubular with member 16 mounted therein. Member 16 is adapted, in combination with barrel 14, to melt the raw material to produce a molten material and to eject a shot of the molten material from barrel 14. Barrel 14 includes heating elements 24 for heating the raw material within barrel 14. In this embodiment, member 16 is also thermally conductive, which allows member 16 to collectively heat the raw material along with heating elements 24.

As depicted, member 16 is a screw 26 with shaft 28 and helical blade 30. Screw 26 is operatively coupled to actuator 22, which rotates screw 26 to move the molten material through barrel 14 towards mold plates 18, 20.

One of the pair of mold plates 18 is coupled to barrel 14. The other of the pair of mold plates 20 is movable relative to the one of the pair 18 for movement between a closed position and an open position. In the closed position, the pair of mold plates define a cavity 32. In the open position, the other of the pair 20 is disposed in spaced relation to one of the pair of mold plates 18.

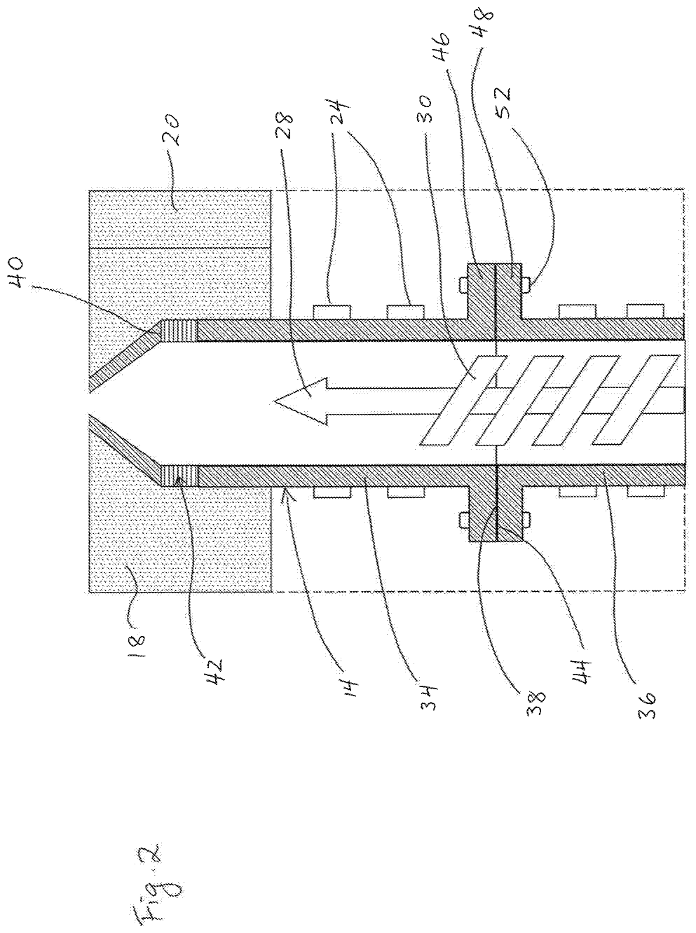

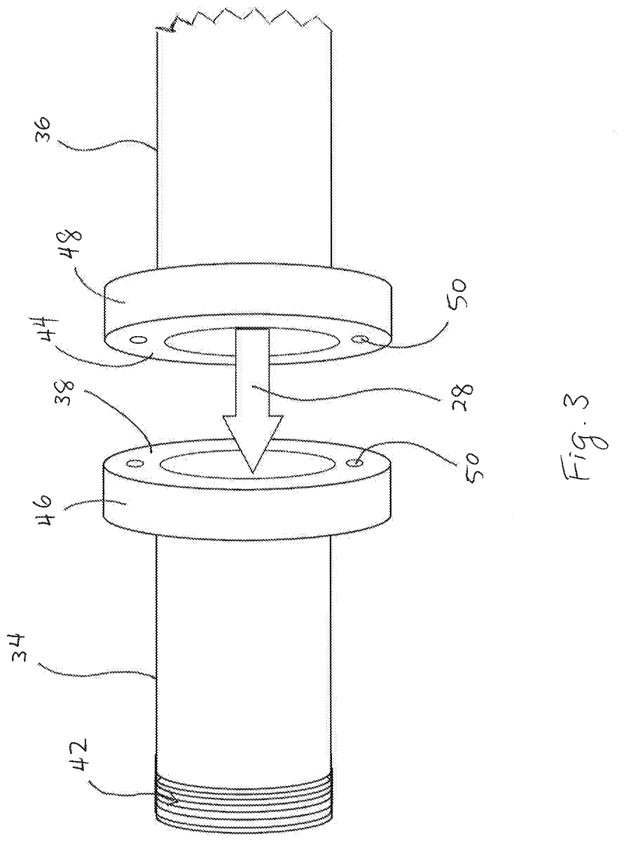

Barrel 14, as seen in FIG. 3, includes a nested part 34 and a protruding part 36. As depicted in FIG. 2, nested part 34 is tubular and has an external end 38 which is disposed exteriorly of one of the pair of mold plates 18 and an internal end 40 which is disposed interiorly of one of the pair of mold plates 18 and engaged therewith. In particular, internal end 40 of nested part 34 has a threaded portion 42 such that internal end 40 is threadedly engaged with one of the pair of mold plates 18. In that regard, one of the pair of mold plates 18 also has a socket with corresponding internal threads to receive and engage with threaded portion 42 of nested part 34.

Protruding part 36 is also tubular, extends towards nested part 34 and is releasably coupled to nested part 34 in end-to-end communicating relation.

External end 38 of nested part 34 and an end 44 of protruding part 36 each have a flange, respectively 46, 48. Flanges 46, 48 have apertures 50 which are adapted to receive bolts 52 therethrough, and thus, be releasably secured together.

While injection molding system 10 may be used independently to melt and inject a material into cavity 32, injection molding system 10 may also form a part of a larger co-injection molding system 100 as a secondary or auxiliary unit. In that manner, co-injection molding system 100 is for use with with a primary material, while injection molding system 10 is for use with a secondary material.

Primary material and secondary material may differ in terms of type, colour or other chemical or physical properties.

Similar to injection molding system 10, co-injection molding system 100 includes a principal hopper 102, a principal barrel 104, a principal member 106 mounted in principal barrel 104, and a principal actuator 108, in addition to injection molding system 10.

Principal hopper 102 is funnel-shaped and positioned in fluid communication with principal barrel 104. Principal barrel 104 is configured to receive the primary material and is larger than barrel 14 of injection molding system 10. Similar to barrel 14, principal barrel 104 is operatively coupled to one of the pair of mold plates 18 and in fluid communication with cavity 32 in the pair of mold plates 18, 20.

Principal member 108 is mounted within principal barrel 104 and is thermally adapted, in combination therewith, to melt the primary material within principal barrel 104.

Similar to injection molding system 10, principal member 106 comprises a principal screw 110 with a shaft and helical blade. Principal screw 108 is operatively coupled to principal actuator 108, which rotates principal screw 110. Principal barrel 104 also has principal heating elements 112 for melting the primary material.

In the embodiment depicted, principal barrel 104 is positioned at an angle from barrel 14 of injection molding system 10.

### Use

To use injection molding system 10, mold plates 18, 20 must first be arranged into the closed position such that cavity 32, for receiving the shot of material and molding a part, is formed. Mold plate 20, in this case, is moved towards and pressed up against mold plate 18.

Nested part 34 is also screwed or threadedly engaged into the socket of mold plate 18. If not already coupled together, protruding part 36 is releasably coupled and secured to nested part 34 in end-to-end communicating relation using bolts 52 directed through apertures 50 in flanges 46, 48. Coupled together in this manner, nested part 34 and protruding part 36 together collectively form barrel 14.

After actuator 22 is activated, pelletized material is directed into hopper 12, which in turn directs the pelletized material into barrel 14. Actuator 22 rotates screw 26 and helical blade 30 moves the pelletized material longitudinally through barrel 14. Heating elements 24 and screw 26 together heat and melt the pelletized material. As screw 26 rotates, the pelletized material melts into molten material and is directed towards the nozzle end of barrel 14 and towards plate 18.

A shot of the molten material is ejected into cavity 32, thereby filling at least a portion of cavity 32 and forming a part (not shown). After the part sets or cures, the other of the pair of mold plates 20 is moved away from mold plate 18, i.e. to be in spaced relation to mold plate 18, for release of the part. In this manner, mold plate 18, which is operatively coupled to barrel 14 is generally stationary in use.

As noted above, injection molding system 10 may be used as part of a co-injection molding system 100.

To use co-injection molding system 100, after mold plates 18, 20 are arranged in the closed position, the primary material in the pelletized form may be introduced into principal hopper 102, which in turns directs the pellets into principal principal barrel 104. As principal screw 110 is turned by principal actuator 108, the pelletized primary material is melted by primary heating elements 112 and principal screw 110. Rotation of principal screw 110 also moves the molten primary material longitudinally through principal barrel 104 towards the nozzle and towards mold plates 18, 20.

As before, a shot of the molten primary material is ejected into cavity 32, thereby filling at least a portion of cavity 32 and forming the part. After the part sets or cures, the other of the pair of mold plates 20 is moved away from mold plate 18, i.e. to be in spaced relation to mold plate 18, for release of the part.

In the case of the co-injecting molding system 100, a shot of the molten primary material from principal barrel 104 and a shot of the molten secondary material from barrel 14 may be ejected into cavity 32 simultaneously or sequentially, depending on the application and the part to be formed.

### Advantages

An advantage of the present invention is that injection molding system 10 is relatively easy to clean between applications given that protruding part 36 is removable from nested part 34 and nested part 34 is itself also removable from mold plate 18.

The removability of protruding part 36 and nested part 34 also allows for simpler changing of secondary material that may be desired to be injected into cavity 32. For example, parts with different colours may be made by simply changing protruding part 36 and/or nested part 34, which in turn thereby changes barrel 14 and hopper 12.

Nested part 34 also provides for a relatively compact package and allows for the shot to be injected relatively proximal to the cavity, thereby simplifying the system and helping to avoid the need for a hot runner.

Whereas a specific embodiment of the method is herein shown and described, variations are possible.

Accordingly, the invention should be understood to be limited only by the accompanying claims, purposively construed.

1. An injection molding system for use with a material, the system comprising:
a heated barrel for receiving the material;
a member mounted in the barrel, the member being adapted, in combination with the barrel, to melt the material to produce a molten material and to eject a shot of the molten material from the barrel;
a pair of mold plates, one of the pair being operatively coupled to the barrel in use, the other of the pair being movable relative to the one of the pair for movement between:
a closed position, wherein the pair of mold plates define a cavity for receiving the shot and molding a part; and
an open position, wherein the other of the pair is disposed in spaced relation to the one of the pair for release of the part,
characterized in that the barrel is defined by a nested part and a protruding part,
the nested part having an external end which is disposed exteriorly of the one of the pair of mold plates and an internal end which, in use, is disposed interiorly of the one of the pair of mold plates and engaged therewith; and
the protruding part, in use, extending to the nested part and being releasably coupled thereto in end-to-end communicating relation.

2. The injection molding system of claim 1, wherein the internal end of the nested part is threaded, such that in use, the internal end is threadedly engaged with the one of the pair of mold plates.

3. The injection molding system of claim 2, wherein the one of the pair of mold plates includes a socket with internal threads for engagement with the internal end of the nested part.

4. The injection molding system of claim 3, wherein the nested part is tubular and the protruding part is tubular.

5. The injection molding system of claim 4, wherein the external end of the nested part and an end of the protruding part each have a flange extending therefrom, the flanges being adapted to be releasably secured together.

6. The injection molding system of claim 5, wherein the barrel includes heating elements for heating the material.

7. The injection molding system of claim 6, wherein the member mounted in the barrel comprises a screw and the molding system includes an actuator operatively coupled to the screw for rotating the screw.

8. A co-injection molding system for use with a primary material and a secondary material, the system comprising:
the injection molding system of claim 1, wherein the material is the secondary material;
a principal barrel for receiving the primary material, the principal barrel operatively coupled to the one of the pair of mold plates;
a principal member mounted in the principal barrel, the principal member being adapted, in combination with the principal barrel, to melt the primary material to produce a molten primary material and to eject a shot of the molten primary material into the one of the pair of mold plates.

9. The co-injection molding system of claim 8, wherein the principal barrel is positioned at an angle from the barrel of the injection molding system.

10. An apparatus comprising:
a pair of mold plates movable relative to one another between:
a closed position, wherein the pair of mold plates define a cavity; and
an open position, wherein one of the pair is disposed in spaced relation to the other one of the pair,
an injection molding mechanism having a barrel for receiving, melting and ejecting a shot of a material into the cavity between the pair of mold plates;
characterized in that:
the barrel of the auxiliary injection molding mechanism comprises a nested part and a protruding part,
the nested part having an external end, which is disposed exteriorly of one of the pair of mold plates, and an internal end which, in use, is disposed interiorly of the one of the pair of mold plates and engaged therein; and
the protruding part, in use, extending to the nested part and being releasably coupled thereto in end-to-end communicating relation.

11. The apparatus of claim 10, wherein the internal end of the nested part is threaded, such that in use, the internal end is threadedly engaged with the one of the pair of mold plates.

12. The apparatus of claim 11, wherein the one of the pair of mold plates includes a socket with internal threads for engagement with the internal end of the nested part.

13. The apparatus of claim 12, wherein the nested part is tubular and the protruding part is tubular.

14. The apparatus of claim 13, wherein the external end of the nested part and an end of the protruding part each have a flange extending therefrom, the flanges being adapted to be releasably secured together.

15. The apparatus of claim 14, wherein the barrel includes heating elements for heating the material.

16. The apparatus of claim 15, further comprising a principal injection molding mechanism of the type for receiving, melting and ejecting a shot of a different material into the cavity between the pair of mold plates.
